(19) United States
(12) Patent Application Publication
(10) Pub. No.: US 2023/0365406 A1
(43) Pub. Date: Nov. 16, 2023

(54) Sulfur Recovery Unit with Fuel Gas Firing

(71) Applicant: Saudi Arabian Oil Company, Dhahran (SA)

(72) Inventor: Turky Saleh Alshuhail, Dhahran (SA)

(21) Appl. No.: 17/745,438

(22) Filed: May 16, 2022

(51) Int. Cl. C01B 17/04

(52) U.S. Cl. CPC C01B 17/0417; C01B 17/043; C01B 17/0452

(57) ABSTRACT

A sulfur recovery unit (SRU) and method including feeding acid gas having hydrogen sulfide to a reaction furnace of the SRU, converting via the SRU the hydrogen sulfide into elemental sulfur and recovering the elemental sulfur, feeding fuel gas instead of the acid gas to the reaction furnace, adjusting flow rate of first air fed to the reaction furnace based on composition of the fuel gas, and adjusting flow rate of second air fed to the reaction furnace based on concentration of oxygen gas (O₂) in furnace gas discharged from the reaction furnace.

### TECHNICAL FIELD

This disclosure relates to the reaction furnace of a sulfur recovery unit.

### BACKGROUND

Hydrogen sulfide can be a byproduct of processing natural gas and refining sulfur-containing crude oils. Other industrial sources of hydrogen sulfide may include pulp and paper manufacturing, chemical production, waste disposal, and so forth. In certain instances, hydrogen sulfide can be considered a precursor to elemental sulfur.

Sulfur recovery may refer to conversion of hydrogen sulfide (H₂S) to elemental sulfur, such as in a sulfur recovery unit (SRU), e.g., Claus system. The most prevalent technique of sulfur recovery is the Claus system, which may be labeled as the Claus process, Claus plant, Claus unit, and the like. The Claus system includes a thermal reactor (e.g., a furnace) and multiple catalytic reactors to convert H₂S into elemental sulfur.

A conventional Claus system can recover between 95% and 98% of H₂S. The percent recovery may depend on the number of Claus catalytic reactors. The tail gas from the Claus system may have the remaining (residual) H₂S, such 2% to 5% of the equivalent H₂S in the feed gas. The Claus tail gas can be treated to recover this remaining H₂S equivalent. In particular, a tail gas treatment (TGT) unit, also known as TGTU, tail gas (TG) unit, and TGU, can increase sulfur recovery to or above 99.9%. Environmental regulations regarding sulfur oxides (SPₓ) emissions may place requirements on sulfur recovery efficiency in commercial sulfur recovery.

### SUMMARY

An aspect relates to a method of operating a sulfur recovery unit (SRU), including feeding acid gas having hydrogen sulfide to a reaction furnace of the SRU. The SRU has a thermal stage including the reaction furnace and a catalytic section including catalytic stages. The method includes converting via the SRU the hydrogen sulfide into elemental sulfur and recovering the elemental sulfur, wherein converting via the SRU the hydrogen sulfide into elemental sulfur includes the reaction furnace and the catalytic stages converting the hydrogen sulfide into elemental sulfur. The method includes feeding fuel gas instead of the acid gas to the reaction furnace, adjusting flow rate of first air fed to the reaction furnace based on composition of the fuel gas, and adjusting flow rate of second air fed to the reaction furnace based on concentration of oxygen gas (O₂) in furnace gas discharged from the reaction furnace.

Another aspect relates to a method of operating a SRU, including feeding acid gas having hydrogen sulfide to a reaction furnace of the SRU in a normal operation of the SRU, wherein the SRU includes a thermal section having the reaction furnace and a catalytic section having catalytic reactors. The method includes converting, via the SRU in the normal operation, the hydrogen sulfide into elemental sulfur and recovering the elemental sulfur, wherein the hydrogen sulfide is converted into elemental sulfur in both the thermal section and the catalytic section. The method includes discontinuing the feeding of the acid gas to the reaction furnace in a special operation including a fuel-gas firing mode of the SRU that is not the normal operation. The method includes feeding fuel gas to the reaction furnace in the special operation, adjusting flow rate of first air fed to the reaction furnace based on composition of the fuel gas, and adjusting flow rate of second air fed to the reaction furnace based on concentration of oxygen gas (O₂) in furnace gas discharged from the reaction furnace.

Another aspect relates to a SRU having a reaction furnace to receive feed and discharge furnace gas through a WHB and through a heat exchanger downstream of the WHB, wherein the feed includes acid gas having hydrogen sulfide in normal operation, wherein the SRU in the normal operation is configured to convert, via the reaction furnace and a catalytic section, the hydrogen sulfide to elemental sulfur and recover the elemental sulfur, and wherein the SRU is configured for a special operation including fuel-gas firing of the reaction furnace with feed including fuel gas and not the acid gas. The SRU includes the WHB to vaporize first water into first steam with heat from the furnace gas, the heat exchanger to cool the furnace gas discharged from the WHB with second water and vaporize the second water into second steam, wherein a thermal stage of the SRU includes the reaction furnace, the WHB, and the heat exchanger. The SRU includes the catalytic section having catalytic stages including a first catalytic stage to receive a discharge stream from the heat exchanger. The SRU includes a control system in the special operation to adjust flow rate of first air fed to the reaction furnace based on composition of the fuel gas and to adjust flow rate of second air fed to the reaction furnace to maintain concentration of oxygen gas (O₂) in the furnace gas discharged from heat exchanger below a threshold.

The details of one or more implementations are set forth in the accompanying drawings and the description below. Other features and advantages will be apparent from the description and drawings, and from the claims.

### BRIEF DESCRIPTION OF DRAWINGS

FIG. 1 is a diagram of a sulfur recovery unit (SRU) that converts hydrogen sulfide into elemental sulfur.

FIG. 2 is a diagram of an example of the thermal section of the SRU of FIG. 1.

FIG. 3 is a logic diagram for control of air supplied to the SRU reaction furnace during the special operation of fuel-gas firing.

FIG. 4 is a diagram of an SRU.

FIG. 5 is a block flow diagram of a method of operating an SRU.

Like reference numbers and designations in the various drawings indicate like elements.

### DETAILED DESCRIPTION

Aspects of the present disclosure are directed to a sulfur recovery unit (SRU) having a reaction furnace that receives acid gas having hydrogen sulfide (H₂S). The SRU converts the H₂S into elemental sulfur and recovers the elemental sulfur. A special operation of the SRU is fuel-gas firing of the reaction furnace in which acid gas is not fed to the reaction furnace. This special operation may be implemented with little or no acid-gas feed to the SRU, such as during unavailability of acid-gas feed or in response to certain maintenance activities of the SRU, and the like. Instead of acid gas, fuel gas is fed to the reaction furnace, such as to keep the SRU on hot standby.

Unfortunately, in operating the SRU on fuel gas firing, the reaction furnace can produce soot that discharges in the furnace gas (exhaust) from the reaction furnace and that can damage the furnace and downstream equipment in the SRU. The soot may be the product of incorrect (e.g., incomplete) fuel gas combustion in the reaction furnace because of incorrect (e.g., inadequate) amount of air fed to the reaction furnace.

Accordingly, in the special operation (operating the SRU on fuel gas firing), the flow rate of main air (e.g., 90% of the total air) fed as combustion air to the reaction furnace may be based on composition (and flow rate) of the fuel gas. The flow rate of the main air may be adjusted to maintain a stoichiometric relationship of air with the fuel gas beneficial for complete and clean combustion of the fuel gas. Further, the flow rate of the trim air (e.g., 10% of the total air fed as combustion air to the furnace) may be based on concentration of oxygen gas (O₂) in the furnace gas discharged from the reaction furnace, such as in the discharged furnace gas routed from the SRU thermal stage to the SRU catalytic section. This control of the main air and the trim air may reduce or prevent production (formation) of soot in the reaction furnace during the fuel-gas firing mode (special operation) of the SRU.

In normal operation, the SRU as a Claus system performs sulfur recovery from feed (e.g., acid gas) having hydrogen sulfide (H₂S). In implementations, the H₂S may be component of acid gas in the feed, and in which H₂S can be less than 50% (volume or weight) of the feed. In implementations, the sulfur compounds in the feed may be primarily H₂S.

As used herein, SRU “H₂S-conversion operating mode” or “SRU in H₂S-conversion operation” may be labeled as normal operation and means the SRU converts H₂S to SO₂ and elemental sulfur, and condenses and recovers elemental sulfur.

As used herein, the SRU “fuel-gas firing mode” or SRU “fuel-gas firing” (or SRU “in fuel-gas firing operation”) may be labeled as a special operation and not a normal operation, and means the reaction furnace (thermal reactor) of the SRU thermal stage is not fed the typical acid-gas or H₂S feed. Instead, the reaction furnace is fed fuel gas to the furnace flame in the reaction furnace. No H₂S conversion or sulfur chemistry is generally performed in the SRU during this special operation.

The sulfur recovery industry has utilized the Claus reaction (gas phase reactions) as the basis for recovering elemental sulfur from H₂S since at least the 1940s. The Claus plant, which is the long-standing workhorse of the industry, uses this chemistry to achieve approximately 95 to 98 percent recovery of the H₂S in the acid gas feed as elemental sulfur (gas phase) which is subsequently condensed (changed from gas to liquid) and recovered in the liquid form.

The majority of Claus plants in operation worldwide include a thermal stage (e.g., a free-flame reaction furnace, waste heat boiler, and condenser) followed by either 2 or 3 catalytic stages (e.g., each catalytic stage including a reheater heat exchanger, a reactor vessel having a catalytic bed, and a condenser heat exchanger) that give practicable recovery efficiencies of about 94%-97% for a 2-stage design (two catalytic stages), or about 96%-99% for a 3-stage design (three catalytic stages).

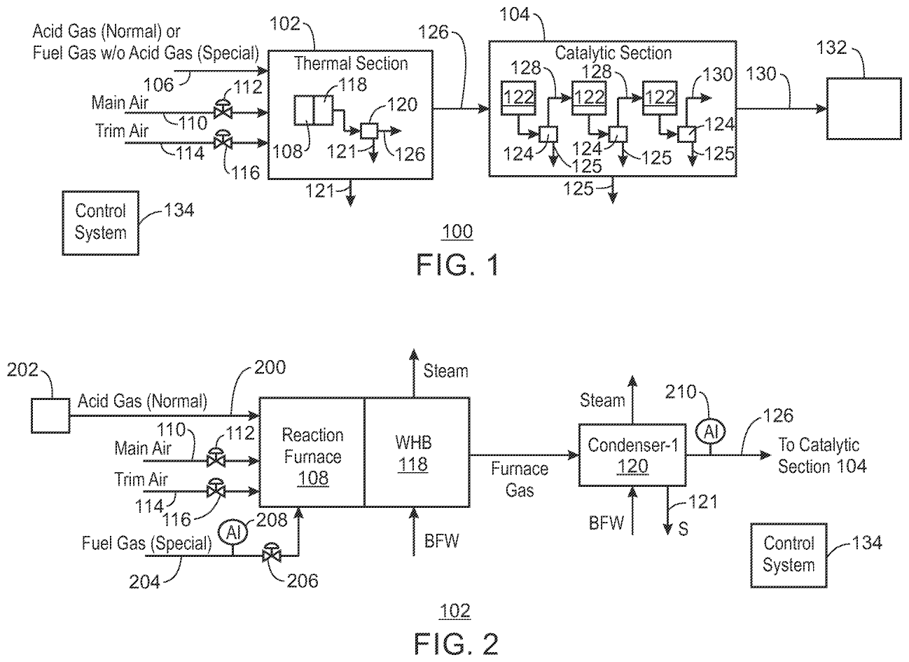

FIG. 1 is a sulfur recovery unit (SRU) 100 that converts H₂S into elemental sulfur. Sulfur recovery may refer to the conversion of H₂S to elemental sulfur (S), and in which the elemental sulfur is recovered. The SRU 100 may be utilized to avoid combusting the full amount of the H₂S in a flare or thermal oxidizer (without sulfur recovery) that could give a significant amount of sulfur dioxide (SO₂) emissions to the environment. In the present context, SO₂ can be a product of H₂S combustion.

Again, the SRU 100 converts H₂S into elemental sulfur and recovers the elemental sulfur. To do so, the SRU 100 (e.g., Claus system) has a thermal section 102 (thermal stage) that converts some of the H₂S into elemental sulfur and a catalytic section 104 (having multiple catalytic stages) that converts some of the H₂S into elemental sulfur. The thermal section 102 and the catalytic section 104 may each condense elemental sulfur for recovery. The recovered elemental sulfur as liquid (not gas) may generally be above the melting point (e.g., 115° C.) of elemental sulfur.

The SRU H₂S-conversion operating mode (hereinafter “normal operation”) that is the typical H₂S-conversion operation means the SRU 100 converts H₂S to SO₂ and elemental sulfur, and condenses and recovers elemental sulfur. In this normal operation (H₂S-conversion operation), acid gas (having H₂S) as feed 106 is provided to a reaction furnace 108 in the thermal stage. First air 110 (main air) is the primary air fed as combustion air to the reaction furnace 108. The first air 110 (main air) may be, for example, at least 90% of the combustion air fed to the reaction furnace 108. In implementations, the flow rate (e.g., controlled via the control valve 112) of the first air 110 may be based on (tied to) the flow rate of the acid gas that is the feed 106 in normal operation. The second air 114 (trim air) may be the remaining (balance of the) combustion air (e.g., less than 10% of the combustion air) fed to the reaction furnace 108. In the normal operation, the flow rate of the second air 114 (trim air) (secondary air) fed as combustion air to the reaction furnace 108 may be controlled (e.g., via the control valve 116) based on, for example, concentration of sulfur compounds (e.g., H₂S and/or SO₂) in one or more process streams downstream in the SRU 100.

The aforementioned special operation (SRU “fuel-gas firing”) of the SRU 100 is placing the reaction furnace 108 on fuel-gas firing in which the feed 106 is fuel gas and not acid gas, and with control of the air 110, 114 that differs from normal operation.

The thermal section 102 may include a waste heat boiler (WHB) 118 and a condenser heat exchanger 120 (e.g., shell-and-tube heat exchanger). In normal operation, the condenser heat exchanger 120 (e.g., with water as cooling medium) may condense elemental sulfur gas into liquid elemental sulfur 121 (molten sulfur) for removal and recovery.

The catalytic section 104 includes multiple catalytic stages (e.g., 2-4) operationally in series. Three catalytic stages are depicted. The number of catalytic stages can instead be two catalytic stages or four catalytic stages. Each catalytic stage may include [1] a catalytic reactor 122 (e.g., Claus reactor) (also called catalytic converter or Claus catalytic converter) that is a reactor vessel 122 having a catalyst bed (e.g., Claus catalyst), and [2] a condenser heat exchanger 124 (e.g., shell-and-tube heat exchanger). In implementations, each catalytic stage may have a reheater, as would be appreciated by one of ordinary skill in the art. In some implementations, the final catalytic stage in the operational series may include a coalescer to remove moisture from the tail gas 130. In a particular implementation, the catalytic reactor 122 in the final catalytic stage in the operational series may be a SuperClaus reactor.

In normal operation, the condenser heat exchanger 124 (e.g., with water as cooling medium) condenses elemental sulfur gas (in the process stream discharged from the reactor vessel 122) into liquid elemental sulfur 125 (molten sulfur) for removal and recovery of the elemental sulfur as liquid. The process stream 128 (gas) discharged from the respective condenser heat exchanger 124 (which is minus elemental sulfur 125 condensed and removed via the heat exchanger 124) may flow to the next reactor vessel 122 in the series, except if the process stream is discharged from the final condenser heat exchanger 124 in which the process stream discharges as tail gas 130 (having residual sulfur compounds) from the catalytic section 104. In normal operation, the process streams 128 and the tail gas 130 may include H₂S and SO₂. In implementations, the tail gas may have generally less than 5 volume percent (vol %) of sulfur compounds, or less than 5 vol % of the combined amount of H₂S and SO₂.

In implementations with the catalytic section 104 having three catalytic stages (and thus three catalytic reactors 122), the sulfur recovery efficiency of the SRU 100 may be, for example, in the range of 95% to 98%. In implementations with the catalytic section 104 having three catalytic stages (and thus three catalytic reactors 122) and with the third (final) catalytic stage being a SuperClaus stage (and thus with the third catalytic reactor 122 as a SuperClaus reactor), the sulfur recovery efficiency of the SRU may be, for example at least 98.6%, in a range of 98.6% to 99.2%.

The percent recovery efficiency of sulfur recovery may refer to the percent of H₂S converted and removed from the feed 106 or refer to the percent of sulfur compounds (including H₂S) converted and removed from the feed 106. The basis may be total sulfur compounds in the feed 106 expressed in terms of equivalent S1 (S1 meaning sulfur compounds with one sulfur atom in a molecule).

The tail gas 130 may flow to a processing system 132, such as a thermal oxidizer for incineration of the tail gas 130 (as the processing). The processing system 132 may be a flare, thermal oxidizer, or tail gas treatment (TGT) unit, and the like.

In the example of a catalytic section 104 having three catalytic stages, the SRU 100 may have at least four heat exchangers that condense elemental sulfur for removal: [a] thermal-stage heat exchanger 120 (condenser-1) and [b] three catalytic-section heat exchangers 124 (condenser-2, condenser-3, and condenser-4). For condensing the elemental sulfur, the condenser heat exchangers 120, 124 may cool the process stream having the elemental sulfur, for example, to in the range of 150° C. to 300° C.

As mentioned for normal operation, the SRU 100 (including the thermal section 102 and the catalytic section 104) converts H₂S into elemental sulfur for removal and recovery of the elemental sulfur 121, 125. In certain implementations, the liquid elemental sulfur 121, 125 may be forwarded to downstream handling or processing, such as a sulfur handling unit. In some implementations, the liquid elemental sulfur 121, 125 (molten sulfur) may be collected, for example, in a sulfur pit before being sent to the sulfur handling unit.

In implementations, each catalytic stage may have a reheater heat exchanger that heats the process stream 126, 128 entering the catalytic reactor 122 of that catalytic stage. The reheater may facilitate control of catalyst bed temperature in the reactor 122. The reheater may be, for example, an indirect steam reheater (e.g., shell-and tube heat exchanger) in which the process stream (gas) is heated with steam as heating medium. The reheater may be, for example, a fired-reheater (e.g., direct-fired heater) (e.g., a burner) that burns fuel gas or acid gas to heat the process stream.

In normal operation, an oxidation reaction in the thermal stage in the reaction furnace 108 (thermal reactor) is 2H₂S+3O₂→2SO₂+2H₂O, which is the oxidation of the entering H₂S from the feed 106 (e.g., acid gas) with oxygen (O₂) gas (e.g., from the added air 110, 114) to give SO₂ and water (H₂O) vapor. The reaction furnace 108 as a thermal reactor may also perform the Claus reaction 2H₂S+SO₂3S+2H2O, in which H₂S gas and SO₂ react to give elemental sulfur (S) gas and water vapor. An overall reaction for the SRU 100 (e.g., Claus system) involving these two reactions (oxidation reaction and Claus reaction) may be characterized as 2H₂S+O₂2S+2H₂O.

The Claus reaction 2H₂S+SO₂→3S+2H₂O may also be performed (as a catalytic reaction) in the catalytic reactors 122 that has catalyst (a catalyst bed) for performing the Claus reaction. The catalyst is employed to convert the H₂S and sulfur dioxide (SO₂) to sulfur. The catalyst (e.g., Claus catalyst) may include activated alumina catalyst. The catalyst may include activated alum inum(III) oxide and/or titanium(IV) oxide. Other Claus catalysts are applicable.

In some implementations, the final catalytic reactor 122 (e.g., third reactor 122) in the series may be a SuperClaus reactor having catalyst (that may be labeled as SuperClaus catalyst) selective for direct oxidation of H₂S. This catalyst may include, for example, an alumina support with iron and chromium oxides as active catalytic material. The SuperClaus direct oxidation of H₂S (e.g., in the final reactor 122) may be represented by the aforementioned overall equation 2H₂S+O₂→3S+2H₂O. In normal operation for implementations with the final reactor 122 in the series as a SuperClaus reactor, air may be provided to the final reactor 122 to promote the direct oxidation of the H₂S. In certain embodiments, the catalytic section 104 may have three catalytic reactors 122 in which the first two catalytic reactors 122 disposed operationally in the series are each a Claus reactor, and the third (and final) catalytic reactor 122 disposed operationally in the series is a SuperClaus reactor.

Embodiments herein of the SRU 100 as a Claus system (that converts H₂S into sulfur and recovers the sulfur) includes the thermal stage (thermal section 102) as an initial stage and having the reaction furnace 108, waste heat boiler 118, and condenser heat exchanger 120. In addition, this Claus system includes multiple Claus catalytic reactors 122 (e.g., at least two Claus catalytic reactors 122) downstream of the thermal stage. A Claus catalytic reactor is defined herein as a reactor having catalyst that performs the Claus reaction. The catalyst in Claus reactors may be Claus catalyst, which is defined as catalyst that performs, advances, or promotes the Claus reaction. A Claus catalytic reactor 122 may be a reactor vessel having the Claus catalyst inside (in the inner volume of) the reactor vessel. The catalyst may be a bed (e.g., fixed bed) of catalyst.

In normal operation (and in the special operation discussed below), the reaction furnace 108 (thermal reactor) may discharge furnace gas through the WHB 118 that recovers heat from the furnace gas to vaporize water (e.g., boiler feedwater) into steam. The furnace gas discharged from the reaction furnace 108 is a combustion product of the reaction furnace 108. In normal operation, furnace gas discharged from the reaction furnace 108 may include H₂S, SO₂, and elemental sulfur. In normal operation (and in the special operation discussed below), the furnace gas flows from the WHB 118 through the condenser heat exchanger 120 to the catalytic section 104. The furnace gas minus any components 121 (e.g., including elemental sulfur in normal operation) condensed and removed via the heat exchanger 120 may flow as the process stream 126 to the first catalytic reactor 122.

In implementations, the process stream 126 may flow through a reheater heat exchanger (not shown) of the catalytic section 104 before entering first catalytic reactor 122. In other implementations, a reheater heat exchanger is not employed. Instead, for instance, in examples of the WHB 120 as a two-pass WHB, a provision of a stream (slipstream) from the first pass of the WHB may mix with the process stream 126 discharged from the condenser 120 (condenser-1) to heat the process stream 126. This type of “process” reheater may be referred to as a Hot Gas Bypass (HGB or HGBP) and is not a reheater heat exchanger but instead the tie-in of one conduit (conveying the HGB slipstream) to another conduit (conveying the process stream 126), such as via a pipe tee.

In embodiments, online analyzer instruments may measure composition of the process stream 126 to the first reactor 122, the process stream(s) 128 (having sulfur compounds) between the reactors 122, and the Claus tail gas 130. Feedback from the online analyzer instruments may be utilized for control of the air supply to the upstream thermal-stage combustion (in the reaction furnace 108). The control system 134 may receive the feedback and implement the control in response to the feedback.

As mentioned, the flow rate of air (and/or O₂) fed to the combustion (to the reaction furnace 108) may be controlled. The ratio (e.g., volume ratio) of the flow rate of air to the flow rate of the process feed 106 (to be com busted) may be controlled to a set point. In normal operation, sulfur recovery efficiency may decrease if the amount (flow rate) of air fed to the combustion is deficient (deficient air) or in excess (excess air). In implementations of normal operation, the adjustment (e.g., via a control system 134) of the air supply rate or the ratio set point of air to feed may be in response to the amounts (concentrations) of H₂S and SO₂ measured in the process streams 126, 128 and/or the tail gas 130. In one embodiment, the adjustment of the air supply (e.g., the trim air 114 flow rate) via the control system 134 may be to maintain or alter the H₂S:SO₂ ratio (e.g., 2:1 by volume or weight) in the process stream 126 discharged from the condenser heat exchanger 120. Controlling such may give or facilitate optimal (or beneficial) efficiency of sulfur recovery by the SRU 100 (Claus system).

The online analyzer instruments may be an online analytical instrument (e.g., online gas chromatograph, online ultra violet (UV)-based analyzer, etc.) disposed along a respective conduit conveying the process streams 126, 128 or tail gas 130. The online analyzer instrument may measure composition (of at least some components) of the process stream or tail gas including the concentrations of H₂S and SO₂ in the process stream or tail gas. The measured concentrations may be, for example, by weight or volume. The online analyzer instrument (if employed) that measures composition of the tail gas 130 may be labeled as a tail gas analyzer.

In implementations, the tail gas 130 may discharge to a thermal oxidizer (or other incineration or combustion system) as the downstream processing system 132. The thermal oxidizer may also be labeled as a thermal incinerator. A thermal oxidizer may decompose and combust gas at high temperature. Thermal oxidizers may be a direct-fired thermal oxidizer, regenerative thermal oxidizer (RTO), catalytic oxidizer, and so on.

Various commercialized flue gas desulfurization (FGD) technologies are available to remove remaining SO₂ from the stack gas of the thermal oxidizer. In a particular present implementation, an FGD unit treats the combustion (incineration) components (flue gas) discharged from the thermal oxidizer to remove SO₂ so that the sulfur recovery efficiency associated with the present Claus system can be increased. The FGD may be, for instance, an SO₂ scrubbing unit including a scrubber tower (column) vessel. The scrubber tower may have, for example, internals to apply alkaline sorbent, spray nozzles for spraying absorbing or reacting fluid, plates or packed beds of packing for providing contact area between the flue gas and a treatment liquid, and so forth. The treatment of the thermal oxidizer flue gas may involve scrubbing the flue gas via the scrubbing tower with an alkali solid or solution.

In implementations, the tail gas 130 may discharge to a TGT unit as the processing system 132. In certain implementations with the SRU 100 having a TGT unit and a catalytic section 104 with two or three catalytic stages (and thus two or three catalytic reactors 122), a 99.9+percent sulfur recovery may be achieved. An example of a TGT unit is a unit employing reduction absorption amine-based technology. This technology employs the reduction and hydrolysis of sulfur compounds back to the form of H₂S, across a catalytic hydrogenation reactor vessel, prior to being processed in a low-pressure amine unit having a vessel. The H₂S that is absorbed into the amine is then regenerated and sent back to the front end of the SRU 100 (Claus plant) as a recycle acid gas feed stream (for feed 106 to the reaction furnace 108).

Again, the SRU 100 may be operated in the SRU “fuel-gas firing mode” or SRU “fuel-gas firing” (or SRU “in fuel-gas firing operation”), all hereinafter “special operation,” and which means the reaction furnace 108 (thermal reactor) of the SRU thermal stage 102 is not fed the typical feed 106 including acid-gas or H₂S. Instead, the reaction furnace 108 is fed fuel gas as the feed 106 to the furnace flame in the reaction furnace 108. In this special operation (and which may considered as not normal operation), no H₂S conversion or sulfur chemistry is generally performed in the SRU 100. Again, this special operation (not normal operation) of the SRU 100 is the reaction furnace 108 placed into a fuel-gas firing mode (a fuel-gas firing operation) in which the feed 106 is not acid gas but is instead, fuel gas. This special operation may be labeled as an alternate operation, hot standby operation, maintenance operation, or abnormal operation. This special operation may be implemented when acid gas is not available for feed 106 or in certain maintenance activities performed in the SRU 100, and the like. Acid gas is not fed in the special operation (and thus no sulfur chemistry is generally perform in the SRU 100 during the special operation). The fuel gas as feed 106 giving fuel-gas firing of the reaction furnace 108 may provide for the SRU 100 to avoid a more significant or complete shutdown and thus be more readily available (in condition) to resume normal operation.

As mentioned, in operating the reaction furnace 108 on fuel-gas firing, the reaction furnace 108 can produce soot that discharges in the furnace gas (exhaust) from the reaction furnace 108 that can damage equipment in the SRU 100. Soot may be impure carbon particles resulting from the incomplete combustion of hydrocarbons in the fuel gas. Soot may be a black powdery or flaky substance consisting largely of amorphous carbon, produced by the incomplete burning of the fuel gas. The soot discharging in the furnace gas from the reaction furnace 108 (during the special operation having the fuel-gas firing of the furnace 108) can foul equipment downstream in the SRU 100 and thus cause backpressure in the SRU 100. The soot may block active sites on catalyst (e.g., alumina catalyst) in the catalytic reactors in the catalytic section 102 and thus deactivate the catalyst.

As indicated, the soot may be the product of incorrect (e.g., incomplete) fuel gas combustion in the reaction furnace 108 because of incorrect (e.g., inadequate) amount of air 110, 114 fed to the reaction furnace 108. Therefore, in accordance with embodiments herein for the special operation (operating the reaction furnace 108 on fuel-gas firing), the flow rate of main air 110 (e.g., 90% of the total air) fed as combustion air to the reaction furnace 108 may be based on composition of the fuel gas as the feed 106. The flow rate of the main air 110 may be adjusted to maintain a stoichiometric relationship with the fuel gas (feed 106 in the special operation) beneficial for complete and clean combustion of the fuel gas. Further, the flow rate of the trim air 114 (e.g., 10% of the total air fed as combustion air to the furnace flame in the furnace 108) may be based on concentration of oxygen gas (O₂) in the furnace gas discharged from the reaction furnace 108, such as in the discharged furnace gas routed from the SRU thermal stage 102 as stream 126 to the SRU catalytic section 104. While the process stream 126 in normal operation may have significant amount of sulfur compounds (e.g., H₂S, SO₂), the stream 126 in the special operation may generally be the discharged furnace gas with little or no sulfur compounds and minus any components 121 (if any) condensed and removed via the heater exchanger 120. The aforementioned control of the main air 110 and the trim air 118 in the special operation may reduce or prevent production (formation) of soot in the reaction furnace 108 during the fuel-gas firing mode (special operation) of the SRU 100.

Lastly, the SRU 100 may include a control system 134 that may facilitate processes of the SRU 100. The control system 134 may direct operation (including operating position) of control valves (e.g., 112, 116) in the SRU 100, receive input from sensors in the SRU 100 regarding operating conditions, receive input from online analytical analyzers, and so forth. The control system 134 may facilitate or direct operation of the system 100, such as with (1) operation of equipment generally, (2) supply or discharge of flow streams (including flowrate and pressure) and associated control valves, (3) receiving data from sensors (e.g., temperature, pressure, composition, etc.) including online analytical instruments, (4) receiving input including constraints from users, (5) performing calculations, (6) specifying set points for control devices, and so on. The control system 134 may determine, calculate, and specify the set point of control devices, and make other control decisions. The determinations can be based on calculations performed by the control system 134 and on operating conditions of the SRU 100 including feedback information from sensors and instrument transmitters, and the like. The control system 134 may receive user input that specifies the set points of control devices or other control components in the SRU 100. The control system 134 typically includes a user interface for a human to enter set points and other targets or constraints to the control system 134. The control system 134 may be communicatively coupled to a remote computing system that performs calculations and provides direction including values for set points.

The control system 134 may be disposed remotely in a control room, or disposed in the field such as with control modules and apparatuses distributed in the field. The control system 134 may include a desktop computer, laptop computer, computer server, programmable logic controller (PLC), distributed computing system (DSC), controllers, actuators, or control cards. The control system 134 may include a processor and memory storing code (e.g., logic, instructions, etc.) executed by the processor to perform calculations and direct operations of the SRU 100. The processor (hardware processor) may be one or more processors and each processor may have one or more cores. The hardware processor(s) may include a microprocessor, a central processing unit (CPU), a graphic processing unit (GPU), a controller card, circuit board, or other circuitry. The memory may include volatile memory (e.g., cache and random access memory), nonvolatile memory (e.g., hard drive, solid-state drive, and read-only memory), and firmware.

Some implementations may include a control room that can be a center of activity, facilitating monitoring and control of the process or facility. The control room may contain a human machine interface (HMI), which is a computer, for example, that runs specialized software to provide a user-interface for the control system. The HMI may vary by vendor and present the user with a graphical version of the remote process. There may be multiple HMI consoles or workstations, with varying degrees of access to data. The control system 134 can be a component of the control system based in the control room. The control system 134 may also or instead employ local control (e.g., distributed controllers, local control panels, etc.) distributed in the SRU 100.

FIG. 2 is an example of the thermal section 102 of the SRU 100 of FIG. 1. The thermal section 102 (which may be called the thermal stage 102) includes the reaction furnace 108 (thermal reactor), the WHB 118, and the condenser heat exchanger 120. In both normal operation and fuel-gas firing mode, the furnace gas (combustion product of the furnace 108) flows through the WHB 118. Steam may be generated in the operation of the WHB 118. In particular, liquid water (e.g., boiler feedwater (BFW), steam condensate, or demineralized water) may be provided to the WHB 118, and heat from furnace gas (from the reaction furnace 108) utilized to vaporize the liquid water into steam. The steam generated may have a pressure, for example, in the range of 150 pounds per square inch gauge (psig) to 600 psig. The steam may generally be saturated steam. As appreciated by one of ordinary skill in the art, BFW can include, for example, treated demineralized water.

The WHB 118 may be integrated with the reaction furnace 108. In one implementation, the WHB 118 is within the reaction furnace 108 and in which a steam drum is mounted on the top of the furnace 108. In some examples, the furnace 108 may include an upfront or upstream burner giving a furnace flame combusting the acid gas or fuel gas and in which the WHB 118 is a shell-and-tube heat exchanger associated with or within the furnace 108 vessel. In these examples, the furnace 108 combustion product as the furnace gas may generally flow through the tubes (tube side) of the heat exchanger. As appreciated by one of ordinary skill in the art, the furnace gas flows through the tube side may be single-pass or two-pass. For the WHB 118 to generate steam, liquid water (e.g., BFW, steam condensate, or demineralized water) flows through the shell side. Heat transfer occurs from the furnace gas in the tube side to the water in the shell side to vaporize the water to generate steam from the liquid water.

The furnace gas discharged from the WHB 118 flows through the condenser 120 to the catalytic section 104. In normal operation, elemental sulfur 121 is condensed and removed from the furnace gas via the condenser 121. The process stream 126 discharges from the condenser 120 to the catalytic section 104 (see FIG. 1). In normal operation, the process stream 126 is cooled furnace gas minus the elemental sulfur 121 removed from the furnace gas 121, and generally has H₂S and SO₂.

In normal operation, acid gas 200 (not fuel gas) is fed (supplied) generally continuously as feed 106 (FIG. 1) to the furnace 108 (to the furnace flame) for thermal reactions. Conversely, for fuel gas firing (the special operation), fuel gas 204 (not acid gas) (not H₂S) is fed generally continuously as feed 106 (FIG. 1) to the furnace 108 (to the furnace flame) for combustion.

In implementations for both normal operation and fuel-gas firing mode, the reaction furnace 108 may be ignited, for example, by mixing fuel gas and air in a combustion chamber and introducing a spark through an igniter. Thereafter, air (having oxygen gas for combustion) may be continuously fed to the reaction furnace 108. This air fed as combustion air to the furnace 108 flame is (refers to) the first air 110 (main air) and the second air 114 (trim air). The air fed to the reaction furnace 108 is the first air and the second air.

The main air 110 flow control valve 112 is labeled hereinafter as “main air valve” 112. The trim air 114 flow control valve 116 is labeled herein as “trim air valve” 116. In implementations, both the main air valve 112 and the trim air valve 116 may receive air supply from the same air source, e.g., air blower(s) or compressors. The main air valve 112 may be along the main-air supply conduit conveying the main air 110. A main-air flow meter may be disposed along the main-air supply conduit to measure flow rate (e.g., volumetric or mass) of the main air 100 and indicate the measured value to the control system 134. The trim air valve 116 may be along the trim-air supply conduit conveying the trim air 114. A trim-air flow meter may be disposed along the trim-air supply conduit to measure flow rate (e.g., volumetric or mass) of the trim air 114 and indicate the measured value to the control system 134.

For both normal operation and fuel-gas firing mode, the trim air valve 116 may provide, for example, less than 10% of the total air fed to the reaction furnace 108, whereas the main air valve 112 may provide, for example at least 90% of the total air supplied to the furnace 108. In implementations, the main air 110 (first air) is at least 80% of air fed to the reaction furnace 108, and the trim air 114 (second air) is less than 20% of the air fed to the reaction furnace 108. The main air 110 may be in the range of 80% to 99% of air fed to the reaction furnace 108. The trim air 114 may be in the range of 1% to 20% of the air fed to the reaction furnace 108.

In normal operation of the SRU, H₂S may be provided as feed 106 (FIG. 1) to the reaction furnace 108. For instance, acid gas 200 having H₂S may be supplied as feed 106 to the reaction furnace 108. The acid gas may additionally have carbon dioxide (CO₂) and other components. As depicted in FIG. 2, acid gas 200 (H₂S, CO₂) is fed from a source 202 to the reaction furnace 108. Acid gas may be known as H₂S and CO₂. The acid gas 200 may have at least 50% (by volume or weight) of a combined amount of H₂S and CO₂. In implementations, the acid gas 108 has H₂S in a range of 10 volume percent (vol %) to 60 vol % and CO₂ in a range of 30 vol % to 80 vol %. The acid gas 200 may additionally include, for example, H₂O and traces of hydrocarbons.

The source 202 of the acid gas 200 may be, for example, a petroleum refinery. Alternatively, the source 202 of the acid gas 200 may be, for example, a natural gas processing plant. If so, the SRU 100 (FIGS. 1-2) may be associated with or disposed in the natural gas processing plant. The source 202 may be an acid-gas removal system that removes acid gas from natural gas and discharges the removed acid gas as the acid gas 200 to the SRU thermal section 102. The acid-gas removal system can be an amine treating unit, Benfield process, Sulfinol® process, or pressure swing adsorption (PSA) unit, and the like.

In normal operation, the reaction furnace 108 (e.g., operating in the range of 1000° C. to 1450° C.) converts H₂S to SO₂ via the oxidation reaction 2H₂S+3O₂→2SO₂+2H₂O, converts H₂S to elemental sulfur via the Claus reaction 2H₂S+SO₂→3S+2H₂O, and in which the combination of these two reactions may be characterized by the equation 2H₂S+O₂→2S+2H₂O. The reaction furnace 108 may convert, for example, 20% to 70% of the entering H₂S (and other sulfur bearing compounds) in the acid gas 200 to elemental sulfur. In normal operation, the furnace gas discharged from the reaction furnace 108 and WHB 118 to the condenser heat exchanger 120 includes H₂S, SO₂, and elemental sulfur. The furnace gas may also include trace amounts of other sulfur compounds, such as carbonyl sulfide (COS) and carbon disulfide (CS₂).

In normal operation (not fuel-gas firing mode) of the SRU, the amount of first air 110 (main air) fed to the furnace 108 may be based, for example, on the feed rate (flow rate) of the acid gas 200 and on a specified air-to-acid gas ratio (e.g., mass or volume). For instance, such a ratio may be specified via input (e.g., user input) to the control system 134, which can also receive indication of the flow rate of the acid gas 200, e.g., as measured via an online sensor or instrument. The set point of the main air valve 112 can be adjusted via the control system 134 to maintain the specified ratio.

Thus, a control scheme for the main air 110 (combustion air) may include ratio control of the flow rate of main air 110 to the flow rate of the acid gas 200. A user may input a ratio set point (as a master set point) into the control system 134 for the desired ratio (e.g., volumetric ratio) of main air 110 to acid gas 200 fed to the reaction furnace 108. In some implementations, the control system 134 may rely on operational feedback from the SRU 100 to alter the set point of the ratio.

A flow meter along the conduit conveying the acid gas 200 to the reaction furnace 108 may measure the flow rate of acid gas 200, and indicate via an instrument transmitter to the control system 134 the flow rate (e.g., volumetric) of the acid gas 200. The aforementioned main-air flow meter along the conduit conveying the main air 110 to the reaction furnace 108 may measure the flow rate of main air 110, and indicate via an instrument transmitter to the control system 134 the flow rate (e.g., volumetric) of the main air 110.

The control system 134 may adjust the flow-rate set point (as a slave set point) of the main air valve 112 to maintain the ratio set point (e.g., a master set point). The control system 134 can also account for air provided to the catalytic section 104 (FIG. 1), such as for oxidation in a catalytic reactor 122 as a SuperClaus reactor (if employed).

As for the trim air 114, the aforementioned trim-air flow meter along the conduit conveying the trim air 114 to the reaction furnace 108 may measure the flow rate of the trim air 114, and indicate via an instrument transmitter to the control system 134 the flow rate (e.g., volumetric) of the main air 114. In normal operation, the flow-rate set point of the trim air valve 116 may depend on operational feedback in the SRU 100. The control system 134 may specify the flow-rate set point of the trim air valve 116 in response to operational feedback from the SRU 100 (Claus system). The operational feedback may include composition of process streams having sulfur compounds. In certain implementations, the SRU 100 includes an online analytical instrument situated along a conduit conveying a process stream (e.g., 126, 128, 130 of FIG. 1) having sulfur compounds In some examples, the online instrument measures the amount or concentration of components (e.g., H₂S and SO₂) in the process stream. The online analytical instrument may be, for example, an online UV-based analyzer that measures concentration of H₂S and SO₂ in the process stream. The analyzer disposed along the conduit conveying the tail gas 130 may be labeled as a tail gas analyzer.

The component concentrations (e.g., for H₂S and SO₂) measure by the online analytical instrument(s) may be indicated via an instrument transmitter to the control system 134. In other words, the instrument transmitter may send a signal indicative of the component concentrations (or amounts) to the control system 134. The control system 134 based on the concentration of H₂S and/or SO₂ measured by one or more of the online analytical instruments may adjust, for example, the set point of the trim air valve 116, as well as adjust the ratio set point of the main air 110 to acid gas 200. Fine-tuning of the flow rates of the combustion air may be beneficial to obtain and maintain the desired overall sulfur recovery efficiency of the SRU 100 (Claus system).

As discussed, for the special operation of the SRU as fuel-gas firing of the reaction furnace 108, fuel gas 204 is fed continuously to the furnace 108 for combustion. The fuel gas 204 may be natural gas that is primarily methane, and may include ethane and propane among other components. The combined amount of methane, ethane, and propane may be at least 98 vol % (or at least 99 vol %, or at least 99.5 vol %) of the fuel gas 204. The flow rate of the fuel gas 204 can be adjusted via the flow control valve 206. The composition of the fuel gas 204 can be measured via an online analytical instrument 208 that indicates a signal indicative of the measure composition to the control system 134. The online analytical instrument 208 can be disposed in the SRU 100 along the conduit conveying the fuel gas 204, or can be in the fuel-gas supply system outside of the SRU 100.

In the special operation (fuel-gas firing mode), acid gas 200 is not fed to the furnace 108. The thermal section 102 does not receive acid gas from the source 202. While trace amounts of acid gas may be in the fuel gas 204, acid gas is not fed as a stream to the furnace 108. In the fuel-gas firing mode, there is generally no sulfur chemistry performed in the SRU. The furnace gas discharged from the WHB 118 generally has no sulfur compounds, and thus are no sulfur compounds 121 to condense and remove via the condenser 120.

In the fuel-gas firing mode, the flow rate of the main air 110 is based on (correlative with) the flow rate of the fuel gas 204 and the composition of the fuel gas 204. The flow-rate set point of the main air valve 112, e.g., set via the control system 134, may be in response to the combination of the flow rate of the fuel gas 204 and the composition of the fuel gas 204. A fuel-gas flow meter along the fuel-gas supply conduit conveying the fuel gas 204 to the reaction furnace 108 may measure the flow rate of fuel gas 204, and indicate via an instrument transmitter to the control system 134 the flow rate of the fuel gas 204. The flow rate indicated to (or calculated by) the control system 134 may be volumetric flow rate, mass flow rate, and molar flow rate. The online analytical instrument 208 situated along the fuel-gas supply conduit (or in the fuel gas supply system) may measure the composition of the fuel gas 204, and indicate via an instrument transmitter to the control system 134 the composition of the fuel gas 204 as measured. The online analytical instrument 208 may be, for example, an online gas chromatograph (GC).

The control system 134 may be configured (programmed) to provide a stoichiometric relationship of amount of air to amount of fuel gas 204 fed to the reaction furnace 108 to prevent or reduce production of soot (due to the combustion) in the furnace 108. The control system 134 may be programmed to consider at least the following three combustion equations: [1] for methane (CH₄), CH₄+2O₂→CO₂+2H₂O; [2] for ethane (C₂H₆), 2C₂H₆ +7O₂→4CO₂+6H₂O; and [3] for propane (C₃H₈), C₃H₈+5O₂→3CO₂+4H₂O. The control may facilitate to implement a logic that automatically maintains stoichiometric firing in the reaction furnace in the fuel-gas firing mode. The control system 134 may apply a factor for excess air to advance complete combustion.

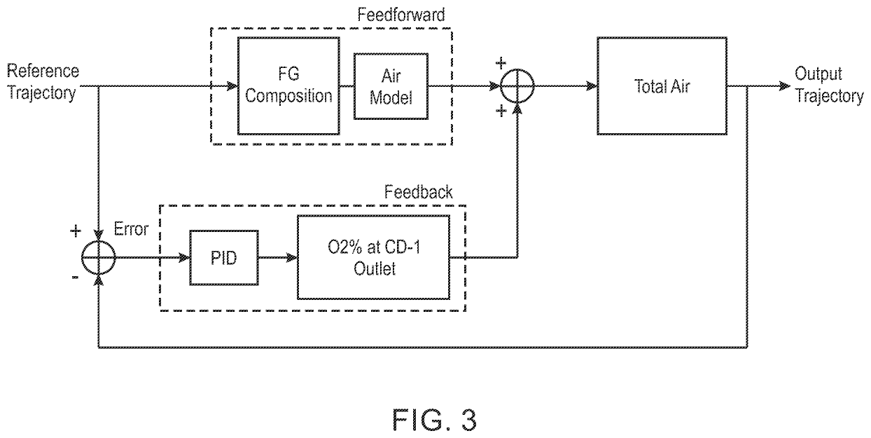

The control system 134 may be programmed with an equation (e.g., stored in memory) to calculate the amount of main air 110 (the flow-rate set point of main air valve 112 to specify) to feed to the furnace 108. The equation may be characterized as an air model or as a required air model (see, e.g., FIG. 3). The equation (calculation) may be based on the flow rate and composition of the fuel gas 204. Below is an example of such an equation, referenced herein as equation (1):

$${n}_{air} = {n}_{FG} \times ( {x}_{C 1} \frac{2 mol {O}_{2}}{1 mol {CH}_{4}} + {x}_{C 2} \frac{\frac{7}{2} mol {O}_{2}}{1 mol {C}_{2} {H}_{6}} + {x}_{C 3} \frac{5 mol {O}_{2}}{1 mol {C}_{3} {H}_{8}} ) \times \frac{1 mol air}{0.21 mol {O}_{2}} \times F$$

where nₐᵢᵣ is molar flow rate of the main air 110 to specify, n_{FG} is molar flow rate of the fuel gas 204, x_{C1} is molar fraction of methane in the fuel gas 204, x_{C2} is molar fraction of ethane in the fuel gas 204, x_{C3} is molar fraction of propane in the fuel gas 204, and F (e.g., 1.005) is a specified excess air factor. The excess air factor may be, for example, in the range of 1.001 to 1.010. Use of the excess air factor F in the equation may be optional (e.g., F=1.000). The equation assumes that air has 21 mole percent of oxygen gas (O₂). The n_{FG} (molar flow rate of the fuel gas 204) may be determined or calculated based on the measured flow rate of the fuel gas 204 and measured composition of the fuel gas 204. The control system 134 may apply the determined nₐᵢᵣ (molar flow rate of main air 110) as the flow-rate set point of the main air valve 112. The control system 134 can convert the determined molar flow rate of the main air 110 to a volume basis or mass basis if desired.

In the fuel-gas firing mode, the flow rate of the trim air 114 may be based on (correlative with) composition (e.g., O₂ concentration) of the furnace gas downstream of the WHB 118, such as upstream of the condenser heat exchanger 120 or in the process stream 126 downstream of the condenser heat exchanger. In the fuel-gas firing mode, the process stream 126 is cooled discharged furnace gas having little or no sulfur compounds, and minus any components condensed and removed by the condenser heat exchanger 120.

As depicted, an analytical instrument 210 is disposed between the condenser heat exchanger 120 and the catalytic section 104 (between the condenser heat exchanger 120 and the first catalytic reactor 122 (FIG. 1)) to measure composition (at least O₂ concentration) of the process stream 126. This online analytical instrument 210 situated along the conduit conveying the process stream 126 may measure the composition of the process stream 126. The instrument 210 or instrument transmitter may indicate the composition of the process stream 126 as measured to the control system 134. The online analytical instrument 210 may be, for example, an online GC or an O₂ analyzer. The online analytical instrument 210 as an O₂ analyzer may be a tunable diode laser.

The flow-rate set point of the trim air valve 116, e.g., set via the control system 134, may be in response to the amount of O₂ (the O₂ concentration) in the process stream 126. The flow rate of the trim air 114 may be specified to maintain the O₂ concentration of the process stream 126 below a threshold, e.g., 0.5 mole percent (mol %). The threshold may be specified, for example, in the range 0.2 mol % to 0.8 mol %. The control system 134 may adjust the set point of the trim air valve 116 to maintain the O₂ concentration in the process stream 126 below the threshold. For example, the control system 134 may decrease the flow-rate set point of the trim air valve in response to the O₂ concentration in the process stream exceeding the threshold. In implementations, the trim air 114 flow rate may be decreased when (in response to) the O₂ concentration in the stream 126, e.g., at are near the condenser 120 (condenser-1) outlet, exceeds the threshold (e.g., 0.5%).

For the fuel-gas firing operating mode, the main air 110 control loop may be an independent control loop in that the main air valve 112 set point does not directly depend on the O₂% measurement downstream of the condenser 120 utilized for the trim air 114 control. In implementations, the main air valve 112 set point may generally not change as long as the fuel gas 204 flow rate and composition remain constant. For the fuel-gas operating mode, the trim air 114 control loop may be an independent control loop in that the flow-rate set point of the trim air valve is changed in response to the O₂ % in the process stream (downstream of condenser 120) and is not changed directly in response to fuel gas composition (or the aforementioned air model).

Thus, the technique may employ a logic (e.g., as represented by FIG. 3) that utilizes a combination of feedforward (composition of the fuel gas) and feedback (O₂ % in a process stream, such as the process stream 126 discharged from the first condenser 120). The logic may be programmed as executable code in the control system 134. The logic may be stored in memory of the control system 134 and executed by a hardware processor of the control system 134. This logic may facilitate that the fuel-gas firing in the reaction furnace 108 is maintained on a stoichiometric ratio by changing the air 110, 114 flowrate depending on the flow rate and composition of the fuel gas composition while maintaining the O₂% in the process stream discharged from the first condenser (condenser-1) below a threshold (e.g., 0.2%, 0.3%, 0.4%, 0.5%, 0.6%, 0.7%, 0.8%, 0.9%, or 1% in volume percent, mole percent, or weight percent. In implementations, the threshold is specified or set in mole percent (mol %). For instance, O₂ % in the process stream may be maintained less than 0.8 mol %, less than 0.6 mol %, less than 5 mol %, between 0 (none) and 0.8 mol %, between 0 and 0.6 mol %, or between 0 and 0.5 mol %. Such may prevent or reduce soot formation in the reaction furnace. The control can be automatic and thus without direct involvement of a human operator.

FIG. 3 is a logic diagram for control of air supplied to the SRU reaction furnace during the special operation of fuel-gas firing. The technique may reduce or prevent soot formation while operating the unit on fuel gas firing by automatically adjusting the set point(s) of airflow. The control may involve automatically adjusting the flow rate of air (both main air and trim air) to the reaction furnace to facilitate that stoichiometric firing is maintained, wherein the reference to stoichiometric is the stoichiometry between air and fuel gas for complete combustion of the fuel gas (and air). A combination of a feedforward control and a feedback control is utilized. The logic consists of both the feedforward control loop and the feedback control loop to determine the flow of air 110, 114 (FIG. 2) to the reaction furnace. The feedforward loop for the air 110 flow depends on the flow rate and composition of the fuel gas. The feedback loop for the air 114 flow depends on O₂ % downstream of the reaction furnace, such as in a process stream (e.g., in the process stream at or near the outlet of the condenser of the thermal stage).

In FIG. 3, the reference trajectory in the depicted logic diagram may be the last reading of the flow rate of the air supplied to the reaction furnace. This may be the combined amount of main air and trim air, but with two separate readings (main air, trim air) of the air supplied available. The output trajectory is the specified flow rate of the air, based on the reference trajectory as adjusted via the control loops of the logic diagram. This may be a single output representing combined flow of main air and trim air, but with two outputs (one for main air and one for trim air) available.

The error is the difference between the measured O₂ % (e.g., vol % or mol %) in the process stream (e.g., 126 of FIG. 2) discharged from the thermal stage condenser (e.g., 120) versus the specified threshold (e.g., 0.5 vol % or 0.5 mol %) (e.g., entered as a set point). In particular, the error is the amount of the measured value above the threshold. The error is zero for all measured values below the threshold. The negative sign feedback (to the error) is the measured O₂ % in the process stream (e.g., 126) discharged from the condenser (e.g. 120 of FIG. 2). The feedback operation (feedback dashed box) for calculating the output for trim air includes a proportional integral derivative (PID) controller and the measured reading value of O₂ %, such as from the online analyzer instrument (e.g., 210 of FIG. 2).

The feedforward operation (feedforward dashed box) includes the measured feed gas composition (e.g., from online analyzer instrument 108 of FIG. 2) and flow rate of fuel gas (as measured by flow meter) that is subjected to the air model, e.g., equation (1) above, to give the output for new flow rate of main air. This is combined in the logic with the trim air from the feedback operation to give the total air.

Thus, the logic includes a combination of the feedforward loop and the feedback loop. The feedforward is (or depends on) the fuel-gas composition and fuel-gas flow rate. This logic (in the control system) may employ the feedforward technique to dynamically change, e.g., via calculation utilizing an equation (air model) the same or similar as equation (1) above, the flow rate of main air to specify to give a stoichiometric ratio of air to the fuel gas (based on fuel gas composition) for combustion. The feedforward may employ an excess air factor (e.g., an extra 0.5%) to facilitate substantially complete combustion and eliminate or reduce soot formation in the reaction furnace. The feedback is (or depends on) excess O₂ % in a process stream (e.g., process stream 126 of FIG. 2). The excess O₂ % is the amount of O₂ % greater than zero. The excess O₂ % is maintained below a threshold (e.g., 0.5%). This feedback loop may fine-tune the air demand (via adjusting trim air) to facilitate that little or no excess air is sent downstream through the SRU. Against, implementation of the described feedforward and feedback could help avoid reaction-furnace soot formation and thus avoid contamination or fouling of downstream equipment in the SRU and excessive loss of Claus catalyst lifetime in downstream catalytic reactors.

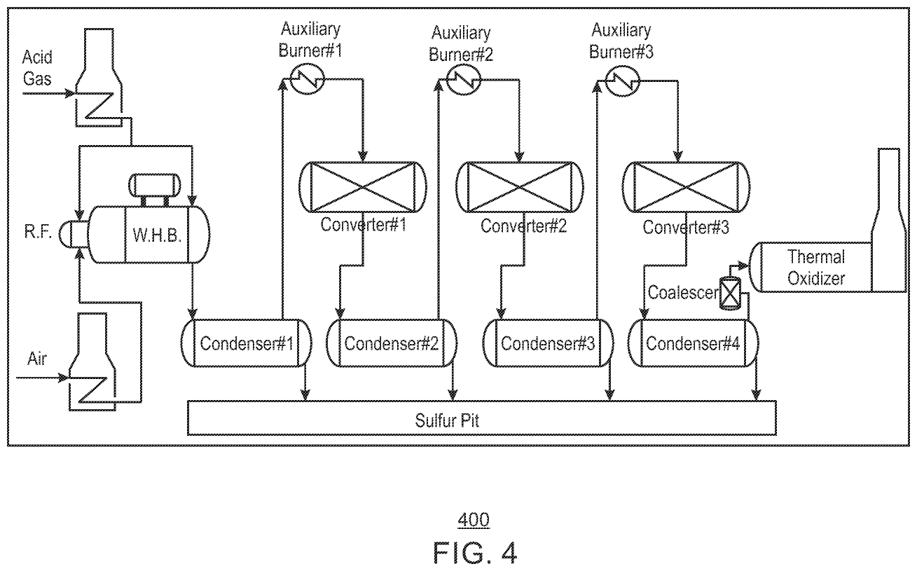

FIG. 4 is an SRU 400 that may employ the present techniques discussed herein, including placing the reaction furnace (RF) in a fuel-gas firing as discussed for the special operation. In fuel-gas firing, fuel gas (not shown) is fed to the RF vessel.

The SRU 400 is a Claus system and may be labeled as a SuperClaus system because the final (third) catalytic reactor (converter #3) is a SuperClaus reactor having SuperClaus catalyst. The SRU 400 converts H₂S and recovers liquid elemental sulfur. The SRU 400 may have a design sulfur-recover efficiency of about 98.6%. The actual sulfur-recovery efficiency in operation may be, for example, in the range of 98% to 99%.

The WHB may be a combustion chamber with a steam drum on top of the vessel. The WHB may be a bundle of tubes immersed in boiler feed water. The steam drum is mounted on top of the furnace to have the tube bundle immersed at all times. Steam (e.g., saturated) is produced from the WHB. The steam may be less than 250 psig, or in the range of 200 psig to 300 psig.

A pretreatment stage may include an acid gas scrubber (not shown), acid gas knockout drum (not shown), acid gas preheater, and air preheater. The SRU 400 has a thermal stage followed by three catalytic stages.

Air (both main air and trim air) may be heated (pre-heated) and fed to the RF, such as the furnace flame or combustion chamber.

In the special operation, fuel gas is fed to RF, such as the furnace flame or combustion chamber. In the special operation, acid gas is not fed to the RF. The flow rate of air (main air and trim air) may be controlled for the special operation as previously discussed.

In normal operation, acid gas (e.g., from an acid-gas removal system, such as an amine treating unit) is heated (pre-heated) and fed to the RF, such as the furnace flame or combustion chamber. In the normal operation, fuel gas is not fed to the furnace flame or combustion chamber. In the illustrated embodiment, a portion (e.g., 20% to 60%) of the acid gas is not burned in the furnace or combustion chamber but instead is fed downstream to mix with furnace gas (combustion products) at an exit part of the RF/WHB vessel.

The thermal stage includes the RF, WHB, and a condenser heat exchanger (Condenser #1). In thermal stage, less than ⅓ of the feed H₂S is burned to SO₂. Elemental sulfur is produced in the RF and then condensed by the first condenser (Condenser #1). Significant heat may be generated in the thermal stage, most of which is recovered in the WHB to produce medium pressure (MP) (e.g., 250 psig) steam that is consumed within the SRU 400. The main chemical reactions in the thermal stage are 2H₂S+3O₂→2SO₂+2H₂O; 6H₂S+3O₂→3S₂+6H₂O; and 4H₂S+2SO₂3S₂+4H₂O.

The SO₂ generated in the RF and discharged from the RF reacts over the catalyst in the first two catalytic stages with H₂S (not converted in the RF) to form elemental sulfur at signficantly lower temperature than RF temperature. The catalytic reaction in the first two catalytic stages (Claus stages) (in converters #1 and #2) includes 2H₂S+SO₂→(3/x)Sₓ+2H₂O. The catalytic reaction in the third catalytic stage (SuperClaus stage) (in converter #3) includes H₂S+(½)O₂→(1/x)Sₓ+H₂O. The elemental sulfur product is removed from the process gas from the catalytic reactors (converter #1, converter #2, converter #3) in the condensers (condenser #1, condenser #2, condenser #3), respectively, by cooling and condensation.

The catalytic section includes three stages. The first two are Claus while the third stage is SuperClaus. Each stage has a re-heater to raise the process gas temperature above sulfur dew point, a catalytic reactor to produce elemental sulfur, and a condenser heat exchanger to condense and remove the elemental sulfur product. In the illustrated implementation, the re-heater is a fired heater that utilizes (burns) fuel to increase the temperature of the acid gas. The word “auxiliary” indicates the re-heater is utilized as supplementary equipment for the catalytic reactors (catalytic converters).

In embodiments, convertor-1 or first catalytic stage (reactor) has catalyst that includes titanium oxide (TiO2) material in the bottom half of the reactor vessel to advance hydrolysis of COS and CS₂ while catalyst in the top half of that reactor vessel is activated alumina. Convertor-2 has an activated alumina catalyst bed. The third convertor, convertor-3, has a SuperClaus catalyst where the catalytic reaction is oxidation of the remaining H₂S directly to elemental sulfur.

The third catalytic stage discharges through a coalescer to a thermal oxidizer. The coalescer is a drum vessel that is relatively large with a demister pad at the outlet of the drum vessel. In operation, the coalescer (drum) collects any droplets of elemental sulfur not in condenser #4. It is located between condenser-4 and the thermal oxidizer.

As illustrated, elemental sulfur may be discharged from the depicted four condensers to a sulfur pit. This produced liquid elemental sulfur may be stored in a heated sulfur pit and transported from the sulfur pit to sulfur handling facilities to be distributed to users or exported to customers.

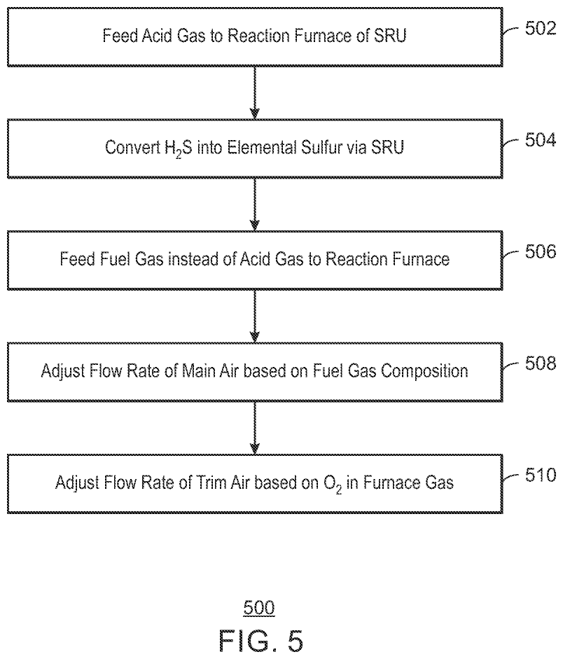

FIG. 5 is a method 500 of operating an SRU (e.g. Claus system). At block 502, the method includes feeding acid gas including hydrogen sulfide (and carbon dioxide) to a reaction furnace (in the thermal stage) of the SRU, such as in the normal operation of the SRU. At block 504, the method includes converting, via the SRU (e.g., in the normal operation), the hydrogen sulfide into elemental sulfur and recovering the elemental sulfur.

At block 506, the method includes feeding fuel gas (e.g., in a special operation) instead of the acid gas to the reaction furnace. The method may include discontinuing the feeding of the acid gas to the reaction furnace in the special operation (e.g., abnormal operation) that is a fuel-gas firing mode of the SRU not the normal operation.

At block 508, the method include adjusting flow rate of first air (main air) fed to the reaction furnace based on (correlative with) composition of the fuel gas. This adjustment may be additionally based on (correlative with) the flow rate of the fuel gas as fed to the reaction furnace. The adjusting of the flow rate of the first air based on the composition of the fuel gas includes adjusting the flow rate of the first air correlative with (in response to) (based on) amount of methane in the fuel gas, amount of ethane in the fuel gas, and amount of propane in the fuel gas.

At block 510, the method includes adjusting flow rate of second air (trim air) fed to the reaction furnace based on concentration of oxygen gas (O₂) in furnace gas discharged from the reaction furnace. The adjusting of the flow rate of the second air based on the concentration of oxygen gas (O₂) in the discharged furnace gas includes adjusting the flow rate of the second air to maintain the concentration of the oxygen gas in the discharged furnace gas below a threshold.

In implementations, the first air is at least 80% of air fed to the reaction furnace, and the second air is less than 20% of the air fed to the reaction furnace. In implementations, the first air is in a range of 80% to 99% of air fed to the reaction furnace, and the second air is in a range of 1% to 20% of the air fed to the reaction furnace.

The method may include discharging the furnace gas from the reaction furnace through a WHB and through a heat exchanger downstream of the WHB, wherein adjusting the flow rate of the second air may involve adjusting the flow rate of the second air based on the concentration of the oxygen gas in the furnace gas as discharged from the heat exchanger. The method may include cooling the furnace gas with water via the heat exchanger, wherein adjusting the flow rate of the second air based on the concentration of oxygen gas in the furnace gas as discharged from the heat exchanger involves adjusting the flow rate of the second air to maintain the concentration of the oxygen gas as discharge from the heat exchanger below a threshold. The threshold may be, for example, in the range of 2 weight percent (wt %) to 8 wt%, or in the range of 2 mol % to 8 mol %.

An embodiment is a method of operating a SRU, feeding acid gas having hydrogen sulfide to a reaction furnace of the SRU, wherein the SRU includes a thermal stage having the reaction furnace and a catalytic section having catalytic stages. The method includes converting, via the SRU, the hydrogen sulfide into elemental sulfur and recovering the elemental sulfur, wherein converting, via the SRU, the hydrogen sulfide into elemental sulfur includes converting the hydrogen sulfide into elemental sulfur via the reaction furnace and the catalytic stages. The method includes feeding fuel gas instead of the acid gas to the reaction furnace, adjusting flow rate of first air fed to the reaction furnace based on composition of the fuel gas, and adjusting flow rate of second air fed to the reaction furnace based on concentration of oxygen gas (O₂) in furnace gas discharged from the reaction furnace. In implementations, the first air is at least 80% of air fed to the reaction furnace, and the second air is less than 20% of the air fed to the reaction furnace. In implementations, the adjusting of the flow rate of the first air based on the composition of the fuel gas includes adjusting the flow rate of the first air correlative with amount of methane in the fuel gas, amount of ethane in the fuel gas, and amount of propane in the fuel gas, and wherein hydrogen sulfide is not fed to the reaction furnace contemporaneous with (at the same time as) the fuel gas is fed to the reaction furnace. In implementations, the adjusting od the flow rate of the second air based on the concentration of oxygen gas (O₂) in the furnace gas includes adjusting the flow rate of the second air to maintain the concentration of the oxygen gas in the furnace gas below a threshold, and wherein hydrogen sulfide is not converted to elemental sulfur in the SRU in the special operation. In implementations, the method includes discharging the furnace gas from the reaction furnace through a waste heat boiler (WHB) and through a heat exchanger downstream of the WHB, wherein the thermal stage has the WHB and the heat exchanger, wherein adjusting the flow rate of the second air includes adjusting the flow rate of the second air based on the concentration of the oxygen gas in the furnace gas as discharged from the heat exchanger. The method may include cooling the furnace gas with water via the heat exchanger, wherein adjusting the flow rate of the second air based on the concentration of oxygen gas in the furnace gas as discharged from the heat exchanger includes adjusting the flow rate of the second air to maintain the concentration of the oxygen gas in the furnace gas as discharged from the heat exchanger below a threshold. The threshold may be, for example, 1 mol %, 3 mol %, 4 mol %, 5 mol %, 6 mol %, 7 mol %, or 8 mol %. Tthe furnace gas as discharged from the heat exchanger may flow to the catalytic section.

Another embodiment is a method of operating a SRU, including feeding acid gas having hydrogen sulfide to a reaction furnace of the SRU in a normal operation of the SRU, wherein the SRU has a thermal section including the reaction furnace and a catalytic section including catalytic reactors. The method includes converting, via the SRU in the normal operation, the hydrogen sulfide into elemental sulfur and recovering the elemental sulfur, wherein the hydrogen sulfide is converted in the normal operation into elemental sulfur in both the thermal section and the catalytic section. The method includes discontinuing the feeding of the acid gas to the reaction furnace in a special operation including a fuel-gas firing mode of the SRU that is not the normal operation. The method includes feeding fuel gas to the reaction furnace in the special operation, adjusting flow rate of first air fed to the reaction furnace based on composition of the fuel gas, and adjusting flow rate of second air fed to the reaction furnace based on concentration of oxygen gas (O₂) in furnace gas discharged from the reaction furnace. In implementations, the first air is in a range of 80% to 99% of air fed to the reaction furnace, and the second air is in a range of 1% to 20% of the air fed to the reaction furnace. In implementations, the adjusting of the flow rate of the first air based on the composition of the fuel gas includes adjusting the flow rate of the first air correlative with an amount of methane in the fuel gas, an amount of ethane in the fuel gas, and an amount of propane in the fuel gas. The method may include discharging the furnace gas from the reaction furnace through a WHB and through a heat exchanger downstream of the WHB, wherein adjusting the flow rate of the second air based on the concentration of the oxygen gas in the furnace gas includes adjusting the flow rate of the second air to maintain the concentration of the oxygen gas in the furnace gas as discharged from the heat exchanger below a threshold. The threshold may be, for example, in a range of 2 mol % to 8 mol %. The method may include cooling the furnace gas with water via the heat exchanger, wherein hydrogen sulfide is not fed to the reaction furnace in the special operation, and wherein hydrogen sulfide is not converted to elemental sulfur in the SRU in the special operation.

Another embodiment is a SRU having a reaction furnace to receive feed and discharge furnace gas through a WHB and through a heat exchanger downstream of the WHB, wherein the feed includes acid gas including hydrogen sulfide in normal operation, wherein the SRU in the normal operation is configured to convert, via the reaction furnace and a catalytic section, the hydrogen sulfide to elemental sulfur, and wherein the SRU is configured for a special operation including fuel-gas firing of the reaction furnace with feed including fuel gas and not the acid gas. The SRU includes the WHB to vaporize first water into first steam with heat from the furnace gas, the heat exchanger to cool the furnace gas discharged from the WHB with second water and vaporize the second water into second steam, wherein a thermal stage of the SRU includes the reaction furnace, the WHB, and the heat exchanger. In implementations, the heat exchanger is a shell-and-tube heat exchanger that cools the furnace gas with the second water as cooling medium and generates the second steam from the second water with heat from the furnace gas, wherein the first water and the second water each include boiler feedwater (BFW). The SRU includes the catalytic section having catalytic stages including a first catalytic stage to receive a discharge stream from the heat exchanger.

The SRU includes a control system to adjust (in the special operation) flow rate of first air fed to the reaction furnace based on composition of the fuel gas and to adjust flow rate of second air fed to the reaction furnace to maintain concentration of oxygen gas (O₂) in the furnace gas discharged from heat exchanger below a threshold. The threshold may be, for example, in a range of 2 mol % to 8 mol %, wherein the first air is at least 80% of air fed to the reaction furnace, wherein the second air is less than 20% of the air fed to the reaction furnace, and wherein the SRU is configured to recover the elemental sulfur. The control system adjusting the flow rate of the first air based on the composition of the fuel gas includes the control system configured (including programmed) to adjust the flow rate of the first air correlative with an amount of methane in the fuel gas, an amount of ethane in the fuel gas, and an amount of propane in the fuel gas. In implementations, the control system adjusting the flow rate of the first air based on the composition of the fuel gas includes the control system configured to adjust the flow rate of the first air correlative with a mole fraction of methane in the fuel gas, a mole fraction of ethane in the fuel gas, a mole fraction of propane in the fuel gas, and an excess air factor. The control system may be configured to receive an indication of the composition of the fuel gas from an on-line analyzer instrument that measures the composition of the fuel gas, wherein the on-line analyzer instrument is disposed in a fuel-gas supply system or along a feed conduit conveying the fuel gas to the reaction furnace, or a combination thereof.

The SRU may include an on-line analyzer instrument to measure the concentration of oxygen gas in the furnace gas as the discharge stream discharged from the heat exchanger and indicate the concentration as measured to the control system, wherein the on-line analyzer instrument is disposed along a discharge conduit conveying the furnace gas as the discharge stream from the heat exchanger to the catalytic section. The catalytic section may be configured to receive the discharge stream from the heat exchanger in both the normal operation and the special operation, and wherein the catalytic stages each include a catalytic reactor to convert hydrogen sulfide into elemental sulfur in the normal operation.

A number of implementations have been described. Nevertheless, it will be understood that various modifications may be made without departing from the spirit and scope of the disclosure.

What is claimed is:

1. A method of operating a sulfur recovery unit (SRU), comprising:
feeding acid gas comprising hydrogen sulfide to a reaction furnace of the SRU, wherein the SRU comprises a thermal stage comprising the reaction furnace and a catalytic section comprising catalytic stages;
converting, via the SRU, the hydrogen sulfide into elemental sulfur and recovering the elemental sulfur, wherein converting the hydrogen sulfide into elemental sulfur via the SRU comprises converting the hydrogen sulfide into elemental sulfur in the reaction furnace and the catalytic stages;
feeding fuel gas instead of the acid gas to the reaction furnace;
adjusting flow rate of first air fed to the reaction furnace based on composition of the fuel gas; and
adjusting flow rate of second air fed to the reaction furnace based on concentration of oxygen gas (O₂) in furnace gas discharged from the reaction furnace.

2. The method of claim 1, wherein the first air is at least 80% of air fed to the reaction furnace, and wherein the second air is less than 20% of the air fed to the reaction furnace.

3. The method of claim 1, wherein adjusting the flow rate of the first air based on the composition of the fuel gas comprises adjusting the flow rate of the first air correlative with amount of methane in the fuel gas, amount of ethane in the fuel gas, and amount of propane in the fuel gas, and wherein hydrogen sulfide is not fed to the reaction furnace contemporaneous with the fuel gas fed to the reaction furnace.

4. The method of claim 1, wherein adjusting the flow rate of the second air based on the concentration of oxygen gas (O₂) in the furnace gas comprises adjusting the flow rate of the second air to maintain the concentration of the oxygen gas in the furnace gas below a threshold, and wherein hydrogen sulfide is not converted to elemental sulfur in the SRU in the special operation.

5. The method of claim 1, comprising discharging the furnace gas from the reaction furnace through a waste heat boiler (WHB) and through a heat exchanger downstream of the WHB, wherein the thermal stage comprises the WHB and the heat exchanger, wherein adjusting the flow rate of the second air comprises adjusting the flow rate of the second air based on the concentration of the oxygen gas in the furnace gas as discharged from the heat exchanger.

6. The method of claim 5, comprising cooling the furnace gas with water via the heat exchanger, wherein adjusting the flow rate of the second air based on the concentration of oxygen gas in the furnace gas as discharged from the heat exchanger comprises adjusting the flow rate of the second air to maintain the concentration of the oxygen gas in the furnace gas as discharged from the heat exchanger below a threshold.

7. The method of claim 6, wherein the threshold is in a range of 2 mole percent (mol %) to 8 mol %, and wherein the furnace gas as discharged from the heat exchanger flows to the catalytic section.

8. A method of operating a sulfur recovery unit (SRU), comprising:
feeding acid gas comprising hydrogen sulfide to a reaction furnace of the SRU in a normal operation of the SRU, wherein the SRU comprises a thermal section comprising the reaction furnace and a catalytic section comprising catalytic reactors;
converting, via the SRU in the normal operation, the hydrogen sulfide into elemental sulfur and recovering the elemental sulfur, wherein the hydrogen sulfide is converted in the normal operation into elemental sulfur in both the thermal section and the catalytic section;
discontinuing the feeding of the acid gas to the reaction furnace in a special operation comprising a fuel-gas firing mode of the SRU that is not the normal operation;
feeding fuel gas to the reaction furnace in the special operation;
adjusting flow rate of first air fed to the reaction furnace based on composition of the fuel gas; and
adjusting flow rate of second air fed to the reaction furnace based on concentration of oxygen gas (O₂) in furnace gas discharged from the reaction furnace.

9. The method of claim 8, wherein the first air is in a range of 80% to 99% of air fed to the reaction furnace, wherein the second air is in a range of 1% to 20% of the air fed to the reaction furnace.

10. The method of claim 8, wherein adjusting the flow rate of the first air based on the composition of the fuel gas comprises adjusting the flow rate of the first air correlative with an amount of methane in the fuel gas, an amount of ethane in the fuel gas, and an amount of propane in the fuel gas.

11. The method of claim 8, comprising discharging the furnace gas from the reaction furnace through a waste heat boiler (WHB) and through a heat exchanger downstream of the WHB, wherein adjusting the flow rate of the second air based on the concentration of the oxygen gas in the furnace gas comprises adjusting the flow rate of the second air to maintain the concentration of the oxygen gas in the furnace gas as discharged from the heat exchanger below a threshold.

12. The method of claim 11, comprising cooling the furnace gas with water via the heat exchanger, wherein the threshold is in a range of 2 mole percent (mol %) to 8 mol %, wherein hydrogen sulfide is not fed to the reaction furnace in the special operation, and wherein hydrogen sulfide is not converted to elemental sulfur in the SRU in the special operation.

13. A sulfur recovery unit (SRU) comprising:
a reaction furnace to receive feed and discharge furnace gas through a waste heat boiler (WHB) and through a heat exchanger downstream of the WHB, wherein the feed comprises acid gas comprising hydrogen sulfide in normal operation, wherein the SRU in the normal operation is configured to convert, via the reaction furnace and a catalytic section, the hydrogen sulfide to elemental sulfur, and wherein the SRU is configured for a special operation comprising fuel-gas firing of the reaction furnace with feed comprising fuel gas and not the acid gas;
the WHB to vaporize first water into first steam with heat from the furnace gas;
the heat exchanger to cool the furnace gas discharged from the WHB with second water and vaporize the second water into second steam, wherein a thermal stage of the SRU comprises the reaction furnace, the WHB, and the heat exchanger;
the catalytic section comprising catalytic stages comprising a first catalytic stage to receive a discharge stream from the heat exchanger; and
a control system in the special operation to adjust flow rate of first air fed to the reaction furnace based on composition of the fuel gas and to adjust flow rate of second air fed to the reaction furnace to maintain concentration of oxygen gas (O₂) in the furnace gas discharged from heat exchanger below a threshold.

14. The SRU of claim 13, wherein the threshold is in a range of 2 mole percent (mol %) to 8 mol %, wherein the first air is at least 80% of air fed to the reaction furnace, wherein the second air is less than 20% of the air fed to the reaction furnace, and wherein the SRU is configured to recover the elemental sulfur.

15. The SRU of claim 13, wherein the control system adjusting the flow rate of the first air based on the composition of the fuel gas comprises the control system configured to adjust the flow rate of the first air correlative with an amount of methane in the fuel gas, an amount of ethane in the fuel gas, and an amount of propane in the fuel gas.

16. The SRU of claim 15, wherein the heat exchanger comprises a shell-and-tube heat exchanger to cool the furnace gas with the second water as cooling medium and generate the second steam from the second water with heat from the furnace gas, and wherein the first water and the second water each comprise boiler feedwater (BFW).

17. The SRU of claim 13, wherein the control system to adjust the flow rate of the first air based on the composition of the fuel gas comprises the control system configured to adjust the flow rate of the first air correlative with a mole fraction of methane in the fuel gas, a mole fraction of ethane in the fuel gas, a mole fraction of propane in the fuel gas, and an excess air factor.

18. The SRU of claim 13, wherein the control system is configured to receive an indication of the composition of the fuel gas from an on-line analyzer instrument that measures the composition of the fuel gas, wherein the on-line analyzer instrument is disposed in a fuel-gas supply system or along a feed conduit conveying the fuel gas to the reaction furnace, or a combination thereof.

19. The SRU of claim 13, comprising an on-line analyzer instrument to measure the concentration of oxygen gas in the furnace gas as the discharge stream discharged from the heat exchanger and indicate the concentration as measured to the control system, wherein the on-line analyzer instrument is disposed along a discharge conduit conveying the furnace gas as the discharge stream from the heat exchanger to the catalytic section.

20. The SRU of claim 13, wherein the catalytic section is configured to receive the discharge stream from the heat exchanger in both the normal operation and the special operation, and wherein the catalytic stages each comprise a catalytic reactor to convert hydrogen sulfide into elemental sulfur in the normal operation.
